(19) United States
(12) Patent Application Publication
(10) Pub. No.: US 2022/0398834 A1
(43) Pub. Date: Dec. 15, 2022

(54) METHOD AND APPARATUS FOR TRANSFER LEARNING

(71) Applicants: BEIJING BAIDU NETCOM SCIENCE TECHNOLOGY CO., LTD., Beijing (CN); State Key Laboratory of Internet of Things for Smart City (University of Macau), Taipa (CN)

(72) Inventors: Xingjian LI, Beijing (CN); Hang HUA, Taipa (CN); Chengzhong XU, Taipa (CN); Dejing DOU, Beijing (CN)

(21) Appl. No.: 17/820,321

(22) Filed: Aug. 17, 2022

(51) Int. Cl. G06V 10/774

(52) U.S. Cl. CPC G06V 10/7747

(57) ABSTRACT

A method for transfer learning includes: obtaining a pre-trained model, and generating a model to be transferred based on the pre-trained model, in which the model to be transferred includes N Transformer layers, and N is a positive integer; obtaining a mini-batch by performing random sampling on a target training set; and training the model to be transferred based on the mini-batch, in which a loss value for each Transformer layer is generated based on an empirical loss value and a noise stability loss value.

### TECHNICAL FIELD

The disclosure relates to the field of computer technology, in particular to a method for transfer learning and an apparatus for transfer learning.

### BACKGROUND

When training the existing deep learning models, there is often a problem of insufficient samples in the dataset, which may lead to poor recognition effect of the trained network. Generally, the methods for transfer learning of models are adopted to improve the model recognition effect. However, there is a lack of methods for transfer learning for multilayer Transformer models.

### SUMMARY

The disclosure provides a method for transfer learning, an apparatus for transfer learning, an electronic device and a storage medium.

According to a first aspect of the disclosure, a method for transfer learning is provided. The method includes:

obtaining a pre-trained model, and generating a model to be transferred based on the pre-trained model, in which the model to be transferred includes N Transformer layers, and N is a positive integer;

obtaining a mini-batch by performing random sampling on a target training set; and

training the model to be transferred based on the mini-batch, in which a loss value for each Transformer layer is generated based on an empirical loss value and a noise stability loss value.

Optionally, generating the model to be transferred based on the pre-trained model, includes:

setting an output dimension of the N^{th} Transformer layer in the pre-trained model as equal to a number of categories of target tasks, in which the number of categories of target tasks is the number of categories of samples in the target training set.

Optionally, the method further includes:

obtaining noise samples, selecting a Transformer layer between the second Transformer layer and the (N−1)^{th} Transformer layer from the model to be transferred with a uniform probability distribution, and determining the selected Transformer layer as an operation Transformer layer;

inputting the mini-batch into the operation Transformer layer for forward calculation, to obtain a first calculation result; and

combining the mini-batch with the noise samples, and inputting into the operation Transformer layer for forward calculation, to obtain a second calculation result, in which the noise stability loss value is generated based on the first calculation result and the second calculation result.

Optionally, data format of the noise samples is identical to data format of the mini-batch.

Optionally, the noise stability loss value is generated by the following equation:

Lr=∥M¹−M0∥², in which Lr is the noise stability loss value, M1 is the first calculation result, and M0 is the second calculation result.

Optionally, the loss value for each Transformer layer is generated by the following equation:

L=Le+λ×Lr, in which L is the loss value for the Transformer layer, λ is an empirical weight, Le is the empirical loss value, and Lr is the noise stability loss value.

According to a second aspect of the disclosure, an apparatus for transfer learning is provided. The apparatus includes: a model to be transferred obtaining module, a sampling module and a training module.

The model to be transferred obtaining module is configured to obtain a pre-trained model, and generate a model to be transferred based on the pre-trained model, in which the model to be transferred includes N Transformer layers, and N is a positive integer.

The sampling module is configured to obtain a mini-batch by performing random sampling on a target training set.

The training module is configured to train the model to be transferred based on the mini-batch, in which a loss value for each Transformer layer is generated based on an empirical loss value and a noise stability loss value.

Optionally, the model to be transferred obtaining module includes:

a dimension adjusting sub-module, configured to set an output dimension of the N^{th} Transformer layer in the pre-trained model as equal to a number of categories of target tasks, in which the number of categories of target tasks is the number of categories of samples in the target training set.

Optionally, the apparatus further includes: a noise obtaining module, a first computing module and a second computing module.

The noise obtaining module is configured to obtain noise samples, select a Transformer layer between the second Transformer layer and the (N−1)^{th} Transformer layer from the model to be transferred with a uniform probability distribution, and determine the selected Transformer layer as an operation Transformer layer.

The first computing module is configured to input the mini-batch into the operation

Transformer layer for forward calculation, to obtain a first calculation result.

The second computing module is configured to combine the mini-batch with the noise samples, and input into the operation Transformer layer for forward calculation, to obtain a second calculation result, in which the noise stability loss value is generated based on the first calculation result and the second calculation result.

Optionally, data format of the noise samples is identical to data format of the mini-batch.

Optionally, the noise stability loss value is generated by the following equation:

Lr=∥M1−M0∥², in which Lr is the noise stability loss value, M1 is the first calculation result, and M0 is the second calculation result.

Optionally, the loss value for each Transformer layer is generated by the following equation:

L=Le+λ×Lr, in which L is the loss value for the Transformer layer, λ is an empirical weight, Le is the empirical loss value, and Lr is the noise stability loss value.

According to a third aspect of the disclosure, an electronic device is provided. The electronic device includes: at least one processor and a memory communicatively coupled to the at least one processor. The memory stores instructions executable by the at least one processor, and when the instructions are executed by the at least one processor, the at least one processor is enabled to implement the method according to the first aspect of the disclosure.

According to the fourth aspect of the disclosure, a non-transitory computer-readable storage medium storing computer instructions is provided. The computer instructions are configured to cause a computer to implement the method according to the first aspect of the disclosure.

According to a fifth aspect of the disclosure, a computer program product including computer programs is provided. When the computer programs are executed by a processor, the method according to the first aspect of the disclosure is implemented.

The noise stability loss value and the Transformer layer loss value are obtained by inputting the noise samples and the mini-batch into the model to be transferred, and transfer learning of the model to be transferred is realized, so that the recognition error rate of the model to be transferred is reduced, the recognition accuracy rate of the model to be transferred is improved, and the robustness of the model to be transferred is improved at the same time.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solution and do not constitute a limitation to the disclosure, in which:

FIG. 1 is a schematic flowchart of a method for transfer learning according to the embodiment of the disclosure.

FIG. 2 is a schematic flowchart of a method for transfer learning according to the embodiment of the disclosure.

FIG. 3 is a structural diagram of an apparatus for transfer learning according to the embodiment of the disclosure.

FIG. 4 is a structural diagram of an apparatus for transfer learning according to the embodiment of the disclosure.

FIG. 5 is a block diagram of an electronic device used to implement the method for transfer learning according to the embodiment of the disclosure.

### DETAILED DESCRIPTION

The following describes the exemplary embodiments of the disclosure with reference to the accompanying drawings, which includes various details of the embodiments of the disclosure to facilitate understanding, which shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

The existing multilayer Transformer models have achieved good results on multiple natural language processing tasks and computer vision tasks. For real tasks, the annotated sample size is often insufficient, and the common compensation method is to fine-tune the pre-trained multilayer Transformer model. However, the training is unstable due to the large amount of model parameters and the limited training samples, the fine-tuning completely fits the training data but the obtained model has weak generalization capability. The direct fine-tuning method tends to overfit the model to parameters with poor generalization capability. The noise stability is related to the generalization capability of the model. If the pre-trained multilayer Transformer is fine-tuned directly, the obtained model is extremely sensitive to input noise, which indicates that the generalization capability of the model obtained by direct fine-tuning is weak. Moreover, there is a lack of transfer learning techniques for multilayer Transformer models.

Based on the method for transfer learning of the embodiments of the disclosure, the noise samples are obtained, the mini-batch is obtained by performing random sampling and input into the model to be transferred for training, and the transferring of the model to be transferred is achieved, so that the recognition error rate of the model to be transferred is reduced, the recognition accuracy rate of the multilayer model to be transferred is improved, and the robustness of the model to be transferred is improved at the same time.

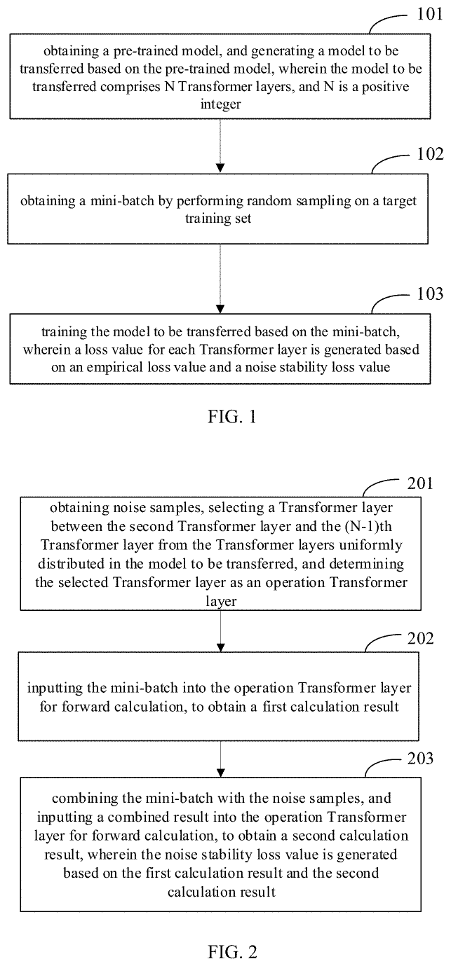

FIG. 1 is a schematic flowchart of a method for transfer learning according to the embodiment of the disclosure. The technical solution of the embodiments of the disclosure can be applicable to various systems, especially neural networks and deep learning systems.

As illustrated in FIG. 1, the method for transfer learning includes the following blocks.

At block 101, a pre-trained model is obtained, and a model to be transferred is generated based on the pre-trained model, in which the model to be transferred includes N Transformer layers, and N is a positive integer.

At block 102, a mini-batch is obtained by performing random sampling on a target training set.

At block 103, the model to be transferred is trained based on the mini-batch, in which a loss value for each Transformer layer is generated based on an empirical loss value and a noise stability loss value.

In a possible implementation, one mini-batch is collected from the target training set at a time until each sample in the target training set is sampled 3 times, i.e., 3 epochs. The mini-batch contains 128 samples.

In order to introduce some randomness, the amount of samples contained in each mini-batch is small, otherwise the gradient direction is too stable and the model to be transferred tends to be easily overfitted.

Moreover, since the gradient updating method is an algorithm that requires a large number of iterations and needs to update the gradient many times to converge the parameters of the model to be transferred, each sample in the target training set needs to be input into the network several times for calculation.

Optionally, generating the model to be transferred based on the pre-trained model, includes:

setting an output dimension of the N^{th} Transformer layer in the pre-trained model as equal to a number of categories of target tasks, in which the number of categories of target tasks is the number of categories of samples in the target training set.

The pre-trained model is a general model, and the structure of the last layer of the pre-trained model generally cannot meet the target task. In a possible case, the pre-trained model divides the input objects of the model into 1000 categories, while the target task is to classify the input objects of the model into 100 categories, which indicates that the concept of categories is different, thus the last layer of the pre-trained model is replaced with a structure of 100 output dimension, and the weight of the last layer of the pre-trained model is initialized randomly, to make the acquired model to be transferred adaptive to the target task.

FIG. 2 is a schematic flowchart of a method for transfer learning according to the embodiment of the disclosure. In a possible embodiment of the disclosure, the method includes the following blocks.

At block 201, noise samples are obtained, a Transformer layer between the second Transformer layer and the (N−1)^{th} Transformer layer is selected from the model to be transferred with a uniform probability distribution, and the selected Transformer layer is determined as an operation Transformer layer.

In a possible implementation, a number e is randomly sampled within a number range [2, N−1] based on uniform distribution probability, and the eh Transformer layer is determined as the operation layer.

The role of the last Transformer layer of the model to be transferred is not to learn representation, but to perform the target task based on the representation learned by the other Transformer layers, which means that the input information of the model has been compressed to only the final classification result by the time the last Transformer layer is reached, so there is no need to set the last Transformer layer as the operation Transformer layer.

The first layer is also removed, and the noise samples can be added to the first Transformer layer. However, for natural language processing tasks, Gaussian noises cannot be superimposed directly on the text, but only on the first representation layer of the network, and it is meaningless to calculate the output loss directly on the layer where Gaussian noises are added, so the first layer is excluded.

Suppose the random variable z conforms to the standard normal distribution N(0, 1) and x=σ·z+μ, then x conforms to the Gaussian distribution N(μ, σ²) with mean μ and variance σ². Therefore, any Gaussian distribution can be obtained from the standard normal distribution by stretching and translating, thus only the sampling of the standard normal distribution is considered here. The common methods for obtaining the noise samples are: inverse permutation method, rejection sampling, importance sampling, and Markov Chain Monte Carlo (MCMC) sampling method.

At block 202, the mini-batch is input into the operation Transformer layer for forward calculation, to obtain a first calculation result.

At block 203, the mini-batch is combined with the noise samples, and input into the operation Transformer layer for forward calculation, to obtain a second calculation result, in which the noise stability loss value is generated based on the first calculation result and the second calculation result.

In a possible implementation, data Di of the mini-batch is input into the model to be transferred for forward calculation, and the output M0 of the operation Transformer layer is obtained, where M0 is the first calculation result.

In a possible implementation, data Di of the mini-batch is combined with the noise sample data Δi, and input into the model to be transferred, that is, Di+Δi is input into the model to be transferred for forward calculation, and the output M1 of the operation Transformer layer is obtained, where M1 is the second calculation result.

Optionally, data format of the noise samples is identical to data format of the mini-batch.

The data format refers to the size of the data. In a possible implementation, the input sample is image data. If the image data format of the mini-batch is (224, 224, 3), then the noise data format should be (224, 224, 3). If the data format of the noise samples and the data format of the mini-batch are different, the noise samples and the mini-batch cannot be combined together, which means that the second calculation result cannot be obtained.

Optionally, the noise stability loss value is generated by the following equation:

Lr=∥M¹−M0∥², in which Lr is the noise stability loss value, M1 is the first calculation result, and M0 is the second calculation result.

Optionally, the loss value for each Transformer layer is generated by the following equation:

L=Le+λ×Lr, in which L is the loss value for the Transformer layer, λ is an empirical weight, Le is the empirical loss value, and Lr is the noise stability loss value.

In a possible implementation, the empirical weight λ=1.

It should be noted that the empirical weight can be adjusted by the implementer according to the actual situation, and the specific value of the empirical weight is not limited in the disclosure.

According to the method, noises are added to the shallow representation of the data, so that the trained target model has stronger generalization capability and higher recognition accuracy rate.

The mini-batch is obtained by performing random sampling and input into the model to be transferred for training, and the transferring of the model to be transferred is achieved, so that the recognition error rate of the model to be transferred is reduced, the recognition accuracy rate of the multilayer model to be transferred is improved, and the robustness of the model to be transferred is improved at the same time.

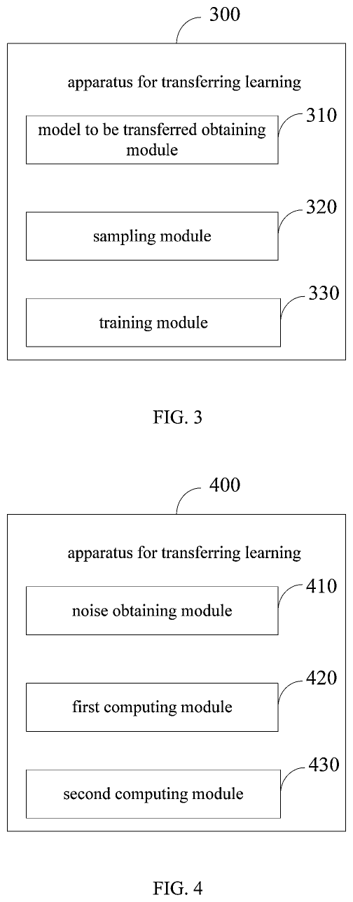

FIG. 3 is a structural diagram of an apparatus for transfer learning according to the embodiment of the disclosure. The apparatus involved in the disclosure may be a deep learning apparatus.

As illustrated in FIG. 3, the apparatus for transfer learning 300 includes: a model to be transferred obtaining module 310, a sampling module 320 and a training module 330.

The model to be transferred obtaining module 310 is configured to obtain a pre-trained model, and generate a model to be transferred based on the pre-trained model, in which the model to be transferred includes N Transformer layers, and N is a positive integer.

The sampling module 320 is configured to obtain a mini-batch by performing random sampling on a target training set.

The training module 330 is configured to train the model to be transferred based on the mini-batch, in which a loss value for each Transformer layer is generated based on an empirical loss value and a noise stability loss value.

Optionally, the model to be transferred obtaining module includes:

a dimension adjusting sub-module, configured to set an output dimension of the N^{th} Transformer layer in the pre-trained model as equal to a number of categories of target tasks, in which the number of categories of target tasks is the number of categories of samples in the target training set.

FIG. 4 is a structural diagram of an apparatus for transfer learning according to the embodiment of the disclosure.

As illustrated in FIG. 4, in a possible implementation, the apparatus for transfer learning 400 includes: a noise obtaining module 410, a first computing module 420 and a second computing module 430.

The noise obtaining module 410 is configured to obtain noise samples, select a Transformer layer between the second Transformer layer and the (N−1)^{th} Transformer layer from the model to be transferred with a uniform probability distribution, and determine the selected Transformer layer as an operation Transformer layer.

The first computing module 420 is configured to input the mini-batch into the operation Transformer layer for forward calculation, to obtain a first calculation result.

The second computing module 430 is configured to combine the mini-batch with the noise samples, and input into the operation Transformer layer for forward calculation, to obtain a second calculation result, in which the noise stability loss value is generated based on the first calculation result and the second calculation result.

Optionally, data format of the noise samples is identical to data format of the mini-batch.

Optionally, the noise stability loss value is generated by the following equation:

Lr=∥M¹−M0∥², in which Lr is the noise stability loss value, M1 is the first calculation result, and M0 is the second calculation result.

Optionally, the loss value for each Transformer layer is generated by the following equation:

L=Le+λ×Lr, in which L is the loss value for the Transformer layer, λ is an empirical weight, Le is the empirical loss value, and Lr is the noise stability loss value.

According to the embodiments of the disclosure, the disclosure provides an electronic device, and a readable storage medium and a computer program product.

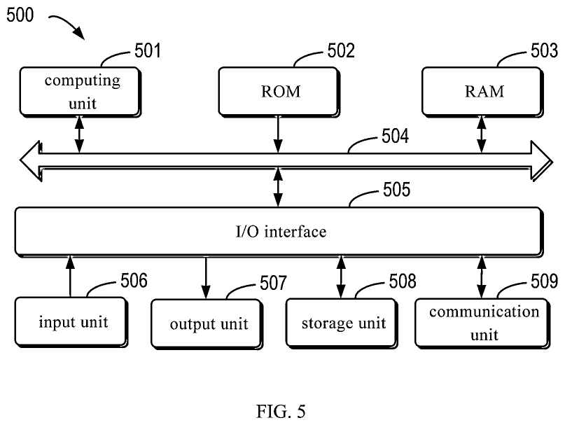

FIG. 5 is a block diagram of an example electronic device 500 used to implement the embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 5, the electronic device 500 includes: a computing unit 501 performing various appropriate actions and processes based on computer programs stored in a read-only memory (ROM) 502 or computer programs loaded from the storage unit 508 to a random access memory (RAM) 503. In the RAM 503, various programs and data required for the operation of the device 500 are stored. The computing unit 501, the ROM 502, and the RAM 503 are connected to each other through a bus 504. An input/output (I/O) interface 505 is also connected to the bus 504.

Components in the device 500 are connected to the I/O interface 505, including: an inputting unit 506, such as a keyboard, a mouse; an outputting unit 507, such as various types of displays, speakers; a storage unit 508, such as a disk, an optical disk; and a communication unit 509, such as network cards, modems, and wireless communication transceivers. The communication unit 509 allows the device 500 to exchange information/data with other devices through a computer network such as the Internet and/or various telecommunication networks.

The computing unit 501 may be various general-purpose and/or dedicated processing components with processing and computing capabilities. Some examples of computing unit 501 include, but are not limited to, a CPU, a graphics processing unit (GPU), various dedicated AI computing chips, various computing units that run machine learning model algorithms, and a digital signal processor (DSP), and any appropriate processor, controller and microcontroller. The computing unit 501 executes the various methods and processes described above, such as the method for transfer learning. For example, in some embodiments, the method may be implemented as a computer software program, which is tangibly contained in a machine-readable medium, such as the storage unit 508. In some embodiments, part or all of the computer program may be loaded and/or installed on the device 500 via the ROM 502 and/or the communication unit 509. When the computer program is loaded on the RAM 503 and executed by the computing unit 501, one or more steps of the method described above may be executed. Alternatively, in other embodiments, the computing unit 501 may be configured to perform the method in any other suitable manner (for example, by means of firmware).

Various implementations of the systems and techniques described above may be implemented by a digital electronic circuit system, an integrated circuit system, Field Programmable Gate Arrays (FPGAs), Application Specific Integrated Circuits (ASICs), Application Specific Standard Products (ASSPs), System on Chip (SOCs), Load programmable logic devices (CPLDs), computer hardware, firmware, software, and/or a combination thereof. These various embodiments may be implemented in one or more computer programs, the one or more computer programs may be executed and/or interpreted on a programmable system including at least one programmable processor, which may be a dedicated or general programmable processor for receiving data and instructions from the storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, random access memories (RAM), read-only memories (ROM), electrically programmable read-only-memory (EPROM), flash memory, fiber optics, compact disc read-only memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: local area network (LAN), wide area network (WAN), the Internet and the block-chain network.

The computer system may include a client and a server. The client and server are generally remote from each other and interacting through a communication network. The client-server relation is generated by computer programs running on the respective computers and having a client-server relation with each other. The server may be a cloud server, a server of a distributed system, or a server combined with a block-chain.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve defects such as difficult management and weak business scalability in the traditional physical host and Virtual Private Server (VPS) service. The server may also be a server of a distributed system, or a server combined with a block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

1. A method for transfer learning, comprising:
obtaining a pre-trained model, and generating a model to be transferred based on the pre-trained model, wherein the model to be transferred comprises N Transformer layers, and N is a positive integer;
obtaining a mini-batch by performing random sampling on a target training set; and
training the model to be transferred based on the mini-batch, wherein a loss value for each Transformer layer is generated based on an empirical loss value and a noise stability loss value.

2. The method of claim 1, wherein generating the model to be transferred based on the pre-trained model, comprises:
setting an output dimension of the N^{th} Transformer layer in the pre-trained model as equal to a number of categories of target tasks, wherein the number of categories of target tasks is the number of categories of samples in the target training set.

3. The method of claim 1, further comprising:
obtaining noise samples, selecting a Transformer layer between the second Transformer layer and the (N−1)^{th} Transformer layer from the model to be transferred with a uniform probability distribution, and determining the selected Transformer layer as an operation Transformer layer;
inputting the mini-batch into the operation Transformer layer for forward calculation, to obtain a first calculation result; and
combining the mini-batch with the noise samples, and inputting a combined result into the operation Transformer layer for forward calculation, to obtain a second calculation result, wherein the noise stability loss value is generated based on the first calculation result and the second calculation result.

4. The method of claim 3, wherein data format of the noise samples is identical to data format of the mini-batch.

5. The method of claim 3, wherein the noise stability loss value is generated by the following equation:
Lr=∥M1−M0∥², wherein Lr is the noise stability loss value, M1 is the first calculation result, and M0 is the second calculation result.

6. The method of claim 5, wherein the loss value for each Transformer layer is generated by the following equation:
L=Le+λ×Lr, wherein L is the loss value for the Transformer layer, λ is an empirical weight, Le is the empirical loss value, and Lr is the noise stability loss value.

7.-12. (canceled)

13. An electronic device, comprising:
at least one processor; and
a memory communicatively coupled to the at least one processor;
wherein, the memory stores instructions executable by the at least one processor, when the instructions are executed by the at least one processor, the at least one processor is enabled to:
obtain a pre-trained model, and generating a model to be transferred based on the pre-trained model, wherein the model to be transferred comprises N Transformer layers, and N is a positive integer;
obtain a mini-batch by performing random sampling on a target training set and
train the model to be transferred based on the mini-batch, wherein a loss value for each Transformer layer is generated based on an empirical loss value and a noise stability loss value.

14. A non-transitory computer-readable storage medium having computer instructions stored thereon, wherein the computer instructions are configured to cause a computer to implement a method for transfer learning, the method comprising:
obtaining a pre-trained model, and generating a model to be transferred based on the pre-trained model, wherein the model to be transferred comprises N Transformer layers, and N is a positive integer;
obtaining a mini-batch by performing random sampling on a target training set; and
training the model to be transferred based on the mini-batch, wherein a loss value for each Transformer layer is generated based on an empirical loss value and a noise stability loss value.

15. (canceled)

16. The electronic device of claim 13, wherein the at least one processor is configured to:
set an output dimension of the N^{th} Transformer layer in the pre-trained model as equal to a number of categories of target tasks, wherein the number of categories of target tasks is the number of categories of samples in the target training set.

17. The electronic device of claim 13, wherein the at least one processor is further configured to:
obtain noise samples, select a Transformer layer between the second Transformer layer and the (N−1)^{th} Transformer layer from the model to be transferred with a uniform probability distribution, and determine the selected Transformer layer as an operation Transformer layer;
input the mini-batch into the operation Transformer layer for forward calculation, to obtain a first calculation result; and
combine the mini-batch with the noise samples, and input a combined result into the operation Transformer layer for forward calculation, to obtain a second calculation result, wherein the noise stability loss value is generated based on the first calculation result and the second calculation result.

18. The electronic device of claim 17, wherein data format of the noise samples is identical to data format of the mini-batch.

19. The electronic device of claim 17, wherein the noise stability loss value is generated by the following equation:
Lr=∥M1−M0∥², wherein Lr is the noise stability loss value, M1 is the first calculation result, and M0 is the second calculation result.

20. The electronic device of claim 19, wherein the loss value for each Transformer layer is generated by the following equation:
L=Le+λ×Lr, wherein L is the loss value for the Transformer layer, λ is an empirical weight, Le is the empirical loss value, and Lr is the noise stability loss value.
